(19) United States
(12) Patent Application Publication
(10) Pub. No.: US 2005/0114123 A1
(43) Pub. Date: May 26, 2005

(54) Speech processing system and method

(76) Inventors: Zelijko Lukac, (US); Dejan Stefanovic, (US)

Correspondence Address: Patrick J. O'Shea;O'Shea, Getz & Kosakowski, P.C., Suite 912, 1500 Main Street, Springfield, MA, 01115, US

(21) Appl. No.: 10/924,237

(22) Filed: Aug. 23, 2004

(30) Foreign Application Priority Data
Aug. 22, 2003 (EP) 03 019036.7

(51) Int. Cl. G10L 19/12

(52) U.S. Cl. 704/222

(57) ABSTRACT

The present invention relates to a speech procession systems comprising a frame handler unit (100) for dividing the incoming speech signal into frames and subframes of samples, a short-term analyzer (200) connected to the frame handler unit (100) for calculating short-term characteristics of the frames of the input speech signal, a short-term redundancy removing unit (250) connected to the short-term analyzer (200) for eliminating short-term characteristics of the frames of the input speech signal and creating noise shaped speech signal, a long-term analyzer (300) connected to the short-term redundancy removing unit (250) for calculating and predicting long-term characteristics of the noise shaped speech signal, a long-term redundancy removing unit (350) connected to the long-term analyzer (300) for eliminating long-term characteristics of the noise shaped speech signal or eliminating short-term and long-term characteristics of the frames of the speech input signal, and in such a way creating a target vector, an excitation pulse search unit (500) connected to the short-term analyzer (200) and the long-term redundancy removing unit (350) for generating sequences of pulses which are to simulate the target vector, wherein every pulse is of variable position, sign and amplitude. Furthermore, the present invention relates to a method of speech processing comprising the steps of dividing the incoming speech signal into frames and subframes, calculating short-term characteristics of the frames of the input speech signal, eliminating short-term characteristics of the frames of the input speech signal and creating noise shaped speech signal, calculating and predicting long-term characteristics of the noise shaped speech signal, eliminating long-term characteristics of the noise shaped speech signal or eliminating short-term and long-term characteristics of the frames of the speech input signal, and in such a way creating a target vector, and generating sequences of pulses of variable position, sign and amplitude which are to simulate the target vector by passing a synthesis filter.

### FIELD OF THE INVENTION

The present invention relates to speech procession systems generally and to excitation pulse search units in particular.

### BACKGROUND OF THE INVENTION

Digital speech processing is used in a lot of different applications. One of the most important applications of speech processing is the digital transmission and storage of speech. Other applications of digital speech processing are speech synthesis systems or speech recognition systems.

Due to the fact that it is desirable to transmit data more quickly and more efficient without loosing speech quality, speech signals are often compressed. For compressing speech signals, typically the speech signal is divided into frames, which are analyzed to determine speech parameters. Usually, there are parameters describing the short-term characteristics and the long-term characteristics of the speech. Linear prediction coefficient (LPC) analysis provides the short-term characteristics, whereas pitch estimation provides the long-term characteristics of the speech signal.

In a common speech processing system, digitalized speech is feed into a LPC analysis unit, which calculates a set of LPC coefficients representing the spectral envelope of the speech frame. The LPC coefficients are often converted to LSP (line spectrum pair) coefficients as described in N. Sugamura, N. Farvardin: “Quantizer Design in LSP Speech analysis-Synthesis”, IEEE Journal on Selected Areas in Communications, Vol. 6, No. 2, February 1988. The LSP coefficients are suitable for quantization. To reflect the quantization error, the LPC coefficients are converted to LSP coefficients, quantized, dequantized and converted back to LPC coefficients.

The LPC coefficients calculated in the previous step are utilized in a noise shaping filter, which is used to filter out short term characteristics of the input speech signal. The noise shaped speech is then passed to a pitch estimation unit, which generates the long-term prediction. A pitch estimation algorithm described in U.S. Pat. No. 5,568,588 uses a normalized correlation method, which requires great amount of processing.

A target vector is generated by subtracting contributions of the short term and long-term characteristics from the speech input signal or by subtracting the long-term contributions from the noise shaped speech. The target vector is then modelled by a pulse sequence. Such a pulse sequence can be obtained using the well-known multi-pulse analysis (MPA). Usually, the pulses are of same amplitude but variable sign and position. A multi-pulse analysis technique described in U.S. Pat. No. 5,568,588 comprises the steps of locating the initial pulse, and subtracting the contribution of the first pulse from the target vector, creating a new target vector this way. Subsequently, a second pulse is found, its contributions are subtracted from the new target vector and this process is repeated until a predetermined number of pulses is found. The amplitudes of all pulses in a sequence are varied around the amplitude of the initial pulse found in the first pass, in a predetermined range in order to find the one pulse amplitude for all pulses in a sequence that best represents the target vector in terms of minimum square error. Thus, for every variation of the pulse amplitude, a complete search procedure is performed to receive the respective pulse sequence. For each pulse sequence received this way, the mean square error between the impulse response and the target vector is calculated. The pulse sequence which has minimum square error is claimed as optimal, and the pulse amplitude used in that pass is also considered as optimal. Therefore, a single gain level, which was associated with the amplitude of the first pulse, is used for all pulses. However, this technique requires a large amount of processor power because a full search is performed for the amplitude of every pulse from the predetermined range.

### SUMMARY OF THE INVENTION

An object of the invention is to create a computationally inexpensive speech compression system, which offers high quality compressed speech. Since many real-world applications of the speech compression system are targeted for platforms that require computationally non-expensive algorithms, there is a need to find blocks in typical speech processing systems that do not fulfil this requirement and to reduce their complexity.

Another object of the invention is to create a memory efficient speech processing system, which besides complexity reduction requires frame size optimization.

Yet another object of the invention is to improve speech quality by improving the precision of pitch estimation and LPC analysis, which is done by optimization of the frame size.

A further object of the invention is to reduce the coder delay, which should be small enough to enable usage of the coder in voice communication.

The present invention introduces methods that reduce computational complexity of the multi-pulse analysis system and the whole speech processing system.

In one embodiment, the excitation pulse search unit (EPS) generates sequences of pulses that simulate the target vector, whereby every pulse is of variable position, sign and amplitude. Therefore, every pulse has the optimal amplitude for a given target signal. According to an aspect of the invention, the optimal pulse sequence is found in a single pass, reducing computational complexity this way.

In a another embodiment, the excitation pulse search unit uses a differential gain level limiting block, which reduces the number of bits needed to transfer the subframe gains by limiting the number of gain levels for the subframes except for the first subframe.

Pulse amplitudes within a single subframe may vary in a limited range, so that the pulses may have the same or a smaller gain than the initial pulse of that subframe, therefore achieving a more precise representation of the target vector and a better speech quality at the price of a higher bit rate.

In a yet another embodiment, the range of the differential coding in the differential gain level limiter block is dynamically extended in cases of very small or very large gain levels by using a bound adaptive differential coding technique.

In one embodiment, a parity selection block is implemented in the excitation pulse search unit, which pre-determines the parity of the pulse positions—they are all even or all odd. In another embodiment, a pulse location reduction block is implemented in the excitation pulse search unit, which further reduces the number of possible pulse positions by limiting the search procedure to referent vector values greater than a determined limit.

The quantization of the LSP coefficients may be optimized using a combination of vector and scalar quantization. In a further embodiment, the quantization of the LSP coefficients may be using optimized vector codebooks created using neural networks and a large number of training vectors.

Furthermore, the pitch estimation unit may be optimized and hierarchical pitch estimation may be based on the well-known autocorrelation technique. The hierarchical search is based on the assumption that the autocorrelation function is a continuous function. In the hierarchical search, in a first pass the autocorrelation function is calculated in every N-th point. In a second pass, a fine search is performed around the maximum value of the possible pitch values received in the first pass. This embodiment reduces the computational complexity of the pitch estimation block.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a block diagram illustration of speech processing system;

FIG. 2 is a block diagram illustration of the LPC analyzing unit;

FIG. 3 is a block diagram illustration of the excitation pulse search unit;

FIG. 4A is a graphical illustration of an example of a target signal;

FIG. 4B is a graphical illustration of a variable amplitude pulse sequence representing the target signal illustrated in FIG. 4A;

FIG. 4C is a graphical illustration approximation of the target signal shown in FIG. 4A (filtered pulse sequence);

FIG. D is a graphical illustration comparison of the target signal shown in FIG. 4A to its approximation shown in FIG. 4C; and

FIG. 5 is a graphical illustration the correlation of the target vector with the impulse response.

### DETAILED DESCPRIPTION OF THE INVENTION

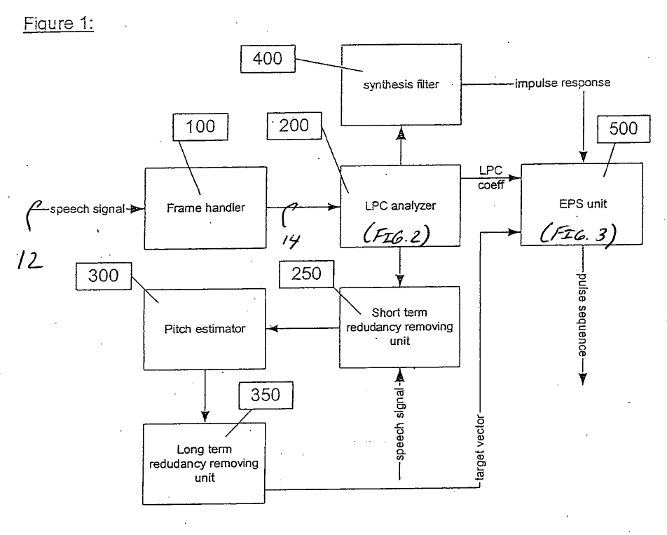

FIG. 1 is a block diagram illustration of a speech processing system 10. Usually, speech processing systems work on digitalized speech signals. Typically, the incoming speech signal a line 12 is digitalized with a 8 kHz sampling rate.

The digitalized speech signal on the line 12 is input to a frame handler unit 100, which in one embodiment works with frames that are 200 samples long. The frames are divided into a plurality of subframes, for example four subframes each 50 samples wide. This frame size has shown optimal performances in aspects of speech quality and compression rate. It is small enough to be represented using one set of LPC coefficients without audible speech distortion. On the other hand, it is large enough from an aspect of bit-rate, allowing a relatively small number of bits to represent a single frame. Furthermore, this frame size allows a small number of excitation pulses to be used for the representation of the target signal.

The speech samples are provided on a line 14 passed on to a short-term analyzer 200, in this embodiment a LPC analyzing unit. LPC analysis may be performed using the Levinson-Durbin algorithm, which creates ten (10) LPC coefficients per subframe of 50 samples.

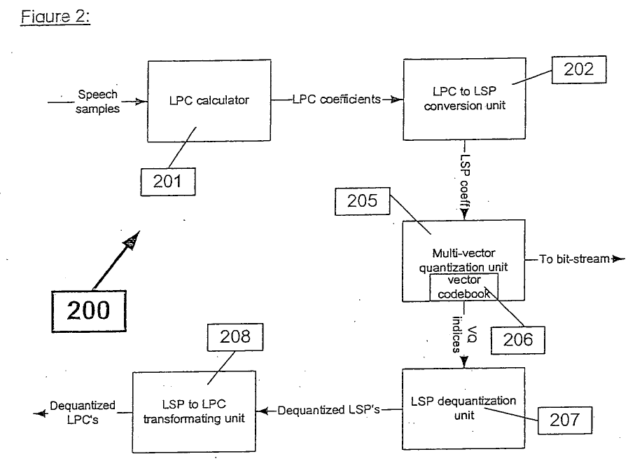

The LPC analyzing unit 200 is described in more detail in FIG. 2. Calculation of the LPC coefficients is performed in a LPC calculator 201, which provides the LPC coefficients to a LPC-to-LSP conversion unit 202. The LPC-to-LSP conversion unit 202 transforms the LPC coefficients that are not suitable for quantization into LSP coefficients suitable for quantization and interpolation.

The LSP coefficients are input to a multi-vector quantization unit 205, which performs quantization of the LSP coefficients. Several alternative embodiments may be used for quantization of the LSP coefficients. First, the vector of ten (10) LSP coefficients is split into an appropriate number of sub-vectors, for example sub-vectors of 3, 3 and 4 coefficients, which are quantized using vector quantization. In an alternative embodiment, a combined vector and scalar quantization of the LSP coefficients is performed. Sub-vectors containing less significant coefficients, for example the first two sub-vectors containing six coefficients, are quantized using vector quantization, while the sub-vectors containing most significant coefficients, in the above mentioned example the third sub-vector containing the last four coefficients, are quantized using scalar quantization. This kind of quantization takes into account the significance of each LSP coefficient in the vector. More significant coefficients are scalar quantized, because this kind of quantization is more precise. On the other hand, scalar quantization needs a larger number of bits. Therefore, less significant coefficients are vector quantized by reducing the number of bits. Although the number of bits may be further reduced by using only vector quantization, the accuracy is significantly improved by using a combination of scalar and vector quantization therefore accepting a slightly increased number of bits. Usually, speech frames corresponding to vocals are highly correlated and are therefore suitable for vector quantization. Speech frames corresponding to consonants are usually not correlated, therefore scalar quantization is used.

In the multi-vector quantization unit 205, vector codebooks 206 are integrated. These vector codebooks 206 used for quantization contain, for example, 128 vector indices per vector that way allowing a reasonably small number of bits to code LSP coefficients. For each vector, a different vector codebook 206 is needed. Preferably, the vector codebooks 206 are not fixed but developed as adaptive codebooks. The adaptive codebooks are created using neural-networks and a large number of training vectors.

Since the quantization of LSP vectors introduces an error, which must be considered in the coding process, inverse quantization of the LSP coefficients is performed using a LSP dequantization unit 207. The dequantized LSP coefficients are input to a LSP-to-LPC conversion unit 208, which performs inverse transformation of the dequantized LSP coefficients to LPC coefficients. The set of dequantized LPC coefficients created this way reflects the LSP quantization error.

Referring again to FIG. 1, the LPC coefficients and the speech samples are input in a short-term redundancy removing unit 250 used to filter out short-term redundancies from the speech signal in the frames. This way, a noise shaped speech signal is created, which is input to a long-term analyzer 300, in this case a pitch estimator.

Any type of long-term analyzer 300 can be used for long-term prediction of the noise shaped speech, which enters the long-term analyzer 300 in frames. The long-term analyzer 300 analyzes a plurality of subframes of the input frame to determine the pitch value of the speech within each two subframes. The pitch value is defined as the number of samples after which the speech signal is identical to itself.

Usually, normalized autocorrelation function of the speech signal of which the short-term redundancies are already removed is used for pitch estimation, because it is known from theory that the autocorrelation function has maximum values on the multiples of the signal period. The method for estimating the pitch period described as follows can be used in any type of speech processing system.

The continual nature of the autocorrelation function is assumed. As a result, in first pass the autocorrelation function can be calculated in every N-th point instead of every point, reducing computational complexity this way. In second pass, search is carried out only in a range around the maximum value calculated in first pass. Instead of the usual search procedure, a hierarchical pitch estimation procedure is performed. The smaller N, the more precise is the calculation of the pitch period. Preferably, N is equal to 2.

In first pass, the maximum of the autocorrelation function is searched using the following formula:

$$\begin{matrix}A h ( n ) = \frac{\sum x ( i ) x ( i - n )}{\sum x ( n - i ) x ( n - i )} \\ 18 \leq n \leq 144 , 0 \leq i \leq 99 , n = 18 + N \cdot k , k = 0 , 1 , 2 , 3 , …\end{matrix}$$

Index i numbers the samples in the frame, due to the subframe length I of 50, i needs not to extend 99. Of course, this formula is not limited to a frame length of 200 and subframes of 50 each, for example, the frame length may contain between 80 and 240 samples. n corresponds to possible pitch values. In this example, pitch values range from 18 to 144, 18 corresponds to a high pitched voice like a female voice, 144 corresponds to a low pitched voice like a male voice.

The result of the first pass is the maximum value of the Ahₘₐₓ(n) and index nₘₐₓ. Smaller values of n are slightly favoured. The second pass of the hierarchical search uses the values calculated in the first pass as a starting point and searches around them to determine the precise value of the pitch period. For the calculation of the second pass, the following formula is used:

$$\begin{matrix}A h ( n ) = \frac{\sum x ( i ) x ( i - n )}{\sum x ( n - i ) x ( n - i )} \\ {n}_{max} - R \leq n \leq {n}_{max} + R , 0 \leq i \leq 99 , n \neq 18 + N \cdot k , k = 0 , 1 , 2 , 3 , …\end{matrix}$$

R represents a range around nₘₐₓ. Typically, R is smaller than N.

In another embodiment of a hierarchical pitch estimation procedure, the possible pitch values are split into three sub-bands: [18-32], [33-70], [70-144]. In this case, the maximum value of the normalized autocorrelation function is calculated for every sub-band, without favouring smaller values, using the same principle of the hierarchical search. As a result, three possible values for the pitch period are received: n₁ₘₐₓ, n₂ₘₐₓ, n₃ₘₐₓ.

In the second pass, the normalized autocorrelation values corresponding to those pitch values are compared, this step favouring of the lower sub-band pitch values is performed by multiplying the normalized autocorrelation values of the higher sub-bands with a factor of 0.875. After the best of the three possible values for the pitch period is found, fine search in the range around this value is performed as described before.

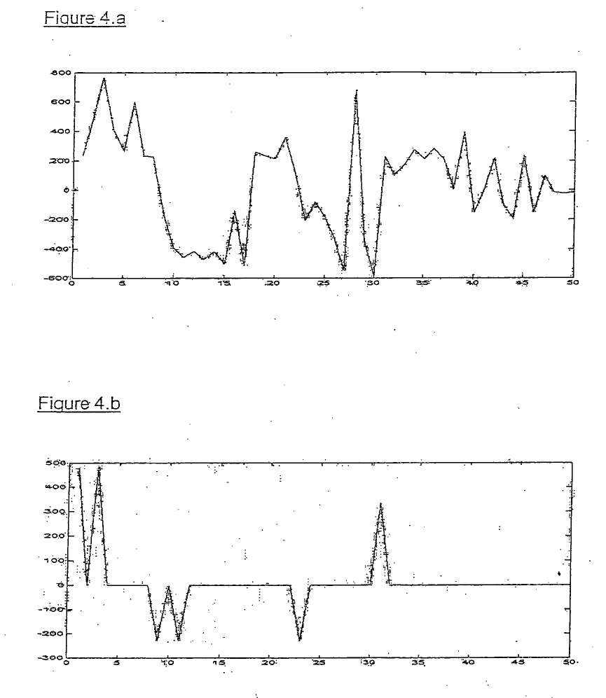

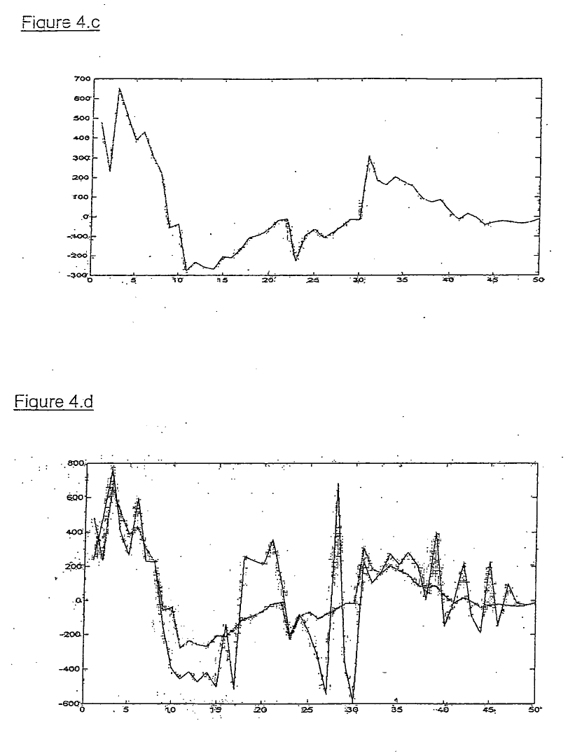

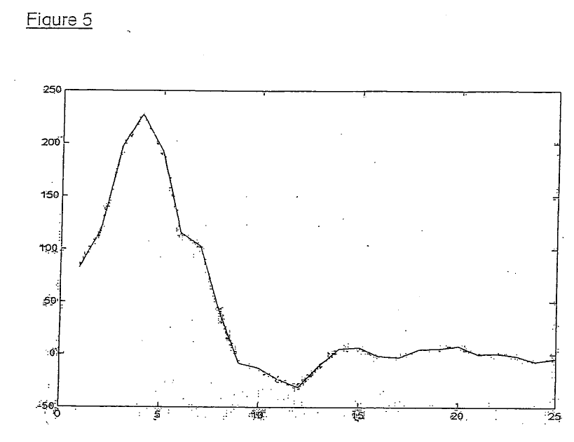

The pitch period and the noise shaped speech are input in a long-term redundancy removing unit 350 to filter out long-term redundancies from the noise shaped speech. This way, a target vector is created. FIG. 4A shows an example of a target vector.

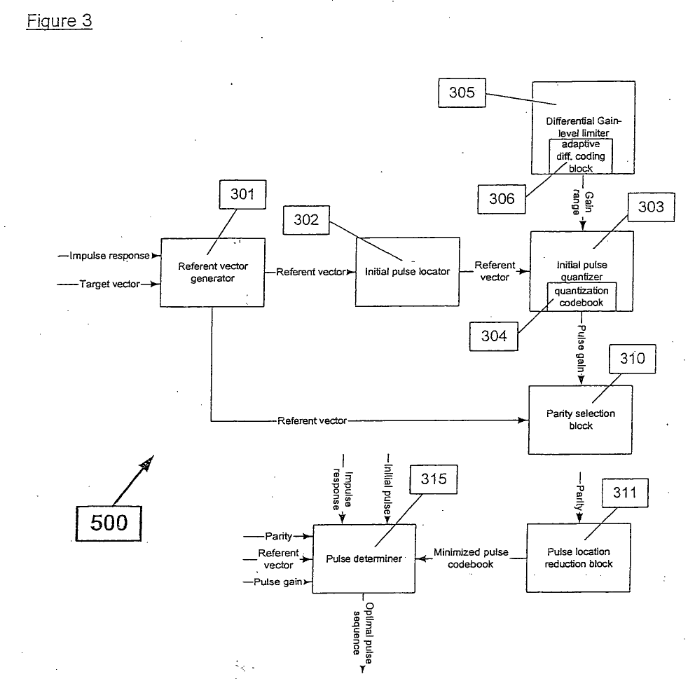

The target vector, the pitch period and the impulse response created in synthesis filter 400 are input to an excitation pulse search unit 500. A block diagram of the excitation pulse search unit 500 is illustrated in FIG. 3. The main task of the excitation pulse search unit 500 is to find a sequence of pulses which, when passed through the synthesis filter, most closely represents the target vector.

The impulse response of the synthesis filter 400 represents the output of the synthesis filter 400 excited by a vector containing a single pulse at the first position. Furthermore, excitation of the synthesis filter 400 by a vector containing a pulse on the n-th position results in an output, which corresponds to the impulse response shifted to the n-th position. The excitation of the synthesis filter 400 by a train of P pulses may be represented as a superposition of P responses of the synthesis filter 400 to the P vectors each containing one single pulse from the train.

Referring to FIG. 3, the preparation step for the excitation pulse search analysis is the generation of two vectors using a referent vector generator 301:
(i) rₜ(n), which is the cross correlation of the target vector and the impulse response of the synthesis filter 400, and
(ii) rᵣ(n), which is the autocorrelation of the impulse response of the synthesis filter 400.
   Since the cross correlation of two vectors represents the measure of their similarity, the vector rₜ(n) is passed on to an initial pulse locator 302 where it is used to determine the position of the first pulse. The location of the first pulse, p₁, is at the absolute maximum of the function rₜ(n), since there is the best match between the impulse response and the target vector. This means that placing a pulse of appropriate amplitude represented by a gain level and sign to the determined position and filtering through said synthesis filter 400 moves the scaled impulse response to the determined position, and the portion of the target vector on that position is matched in the best possible way.

To reduce the number of bits needed to represent the pulse sequence from the excitation pulse search unit 500, the maximum of rₜ(n) from the first step is passed on to a initial pulse quantizer 303 where it is quantized using any type of quantizer, without loss of generality for this solution. The result of this quantization is the initial gain level G. In this embodiment, a further reduction of bit-rate is achieved using a differential gain-level limiter 305.

Our research has shown that in most cases, the quantized gains of the pulses for the subframes in a single frame vary around the quantized gain from the first subframe in a small range that may be coded differentially. The differential gain level limiter 303 controls the quantization process of the pulse gains for the subframes, allowing the gain of the first subframe to be quantized using any gain level assured by used quantizer, and for all other subframes it allows only ±gᵣ gain levels around the gain level from the first subframe to be used. This way, the number of bits needed to transfer the gain levels can be reduced significantly.

The differential gain level limiter 305 comprises a bound adaptive differential coding block 306, which dynamically extends the range of differential coding in cases of very small or very large gain levels. This method is going to be explained using a simple example. Granted that the initial pulse quantizer 303 works with 16 discrete gain levels, indexed from 0 to 15, and gᵣ=3. Let the quantized gain of the first pulse of the first subframe correspond to the first index of a quantization codebook 304. If the standard differential quantization is used, the gain levels for the other subframes may correspond to the codebook indices 0, 1, 2, 3 and 4. It is clear that using the whole range of values smaller than 1, which is the reference index for the differential coding, has no sense. The method of bound adaptive differential coding considers the fact that the reference index is also transmitted to the decoder side, so that the full range of the differential values may be used, simply by translating the differential values in order to represent differences −1, 0, 1, 2, 3, 4 and 5 to reference index instead of −3, −2, −1, 0, 1, 2, 3. This way, the range of the gain levels for the other subframes is extended with the quantization codebook indices 5 and 6. The same logic may be used, for example, when the reference index has a value of 14.

It is common practice in multi pulse analysis coders to place the pulses on even or odd positions only, due to bit rate reduction. This specific embodiment also uses this technique, but, unlike other embodiments, which are choosing even or odd positions by performing multi pulse analysis for both cases and then selecting the positions that better match the target vector, this embodiment predetermines either even or odd positions are going to be used before performing the multi pulse analysis, using a parity selection block 310. In the parity selection block 310, the energies of the vectors rₜ(n) and rᵣ(n) scaled by the quantized gain level are calculated for both even and odd positions. The parity is determined by the greater energy difference, so that the multi pulse analysis procedure may be performed in a single pass. This way, the computational complexity is reduced.

To further reduce the number of possible candidate sample positions, the excitation pulse search unit 500 includes a pulse location reduction block 311, which removes selected pulse positions using the following criteria: if the vector rₜ at the position n has a value that is below 80% of the quantized gain level, the position n is not a pulse candidate. This way, a minimized codebook is generated. In case when the number of pulse candidates determined this way is smaller than a predetermined number M of pulses, the results of this reduction are not used, and only the reduction made by the parity selection block 310 is valid.

At this point, the position and the gain of the first pulse, the parity and the pulse candidate positions are known. The other M-1 pulses are about to be determined. For generating the optimized pulse sequence, a pulse determiner 315 is used, receiving the referent vector generated by the referent vector generator 301, the impulse response generated by the synthesis filter 400 (FIG. 1), the initial pulse generated by the initial pulse locator 302 (FIG. 3), the parity generated by the parity selection block 310, the pulse gain generated by the differential gain limiter block 305 and the minimized codebook generated by the pulse location reduction block 311.

The contribution of the first pulse is removed from the vector rₜ(n) by subtracting the vector rᵣ(n−p₁) that is scaled by the quantized gain value. This way, a new target vector is generated for the second pulse search. The second pulse is searched within the pulse positions, which are claimed as valid by the parity selection block 310 and the pulse location reduction block 311. Similarly to the first pulse, the second pulse is located at the position of the absolute maximum of the new target vector rₜ(n). Unlike the multi pulse analysis method, which uses the same gain for all pulses, this specific embodiment uses different gain levels for every pulse. Those gains are less or equal to the gain of the initial pulse, G. To reduce the number of bits necessary to represent variable gains, the quantization range under G is limited to Q discrete gain levels. It is clear that, for Q=0, all pulses have an equal gain. A difference between the G index and the quantized gain index for every pulse ranges from 0 to Q. The contribution of the second pulse is then subtracted from the target vector, and same search procedure is repeated until the predetermined number of pulses M is found. The pulse sequence of pulses with variable amplitude representing the target vector shown in FIG. 4A is shown in FIG. 4B. The impulse response obtained by filtering this pulse sequence, which yields the approximation of the target vector, is pictured in FIG. 4C. FIG. 4D compares the target signal shown in FIG. A to the approximation of the target vector shown in FIG. 4C.

An advantage of the algorithm for finding the pulse sequence representing the target vector is illustrated in FIG. 5 showing an example of the cross correlation of the target vector with the impulse response. The function illustrated in FIG. 5 has one maximum larger than the rest of the signal. This peak can be simulated for example using two pulses of a large amplitude. This way, the peak is slightly “flattened”. The next pulse position could be around position 12 on the x-axis. If, like using multi pulse analysis or maximum likelihood quantization multi pulse analysis, a pulse with the amplitude of the initial pulse is used for approximating this smaller peak, the approximation will probably be quite bad. If the amplitude of the pulses may vary, the next pulse may be smaller than the initial pulse. Therefore, it is possible to derive a better simulation of the target signal with varying amplitudes. In this case, the advantage of using a sequence of pulses, wherein every pulse in the sequence has an amplitude that is less or equal to the amplitude of the initial pulse, can be seen: For every pulse found in the search procedure, its contribution is subtracted from the target vector, which basically means that the new target signal is a flattened version of the previous target signal. Therefore, the new absolute maximum of the new target vector, which is the non-quantized amplitude of the next pulse, is equal or smaller than the value found in the preceding search procedure. Using this algorithm, every pulse has the optimum amplitude for the area of the target signal it emulates, therefore the minimum square error criterion is not used, this way further reducing calculation complexity.

In another embodiment of present invention, an additional pulse locator block is used. This embodiment is more suitable for small number of pulses.

Usually, the excitation pulse search unit 500 places pulses on even or odd positions only. In this specific embodiment, assuming 48 different positions of pulses, even or odd positions are further split into smaller groups. For even positions, the three following groups of pulses are created:
I [2,8,14,20,26,32,38,44]
II [4,10,16,22,28,34,40,46]
III [6,12,18,24,30,36,42,48]
   For odd positions, the three following groups of pulses are created:
I [1,7,13,19,25,31,37,43]
II [3,9,15,21,27,33,39,45]
III [5,11,17,23,29,35,41,47]
   The splitting of the positions can as well be performed accordingly for larger numbers of positions.

The preparation step for the excitation pulse analysis is the same as described above using the referent vector generator 301. The next step, the determination of the initial gain, differs slightly due to the different grouping of pulses. In this case, the initial pulse is searched on group-by-group basis, and after the initial pulse is found, the gain value is quantized the same way as described before.

The group containing the initial pulse is removed from the further search. The functionality of the differential gain level limiter 305 and the parity selection block 310 is the same as previously described. The pulse location reduction block 311 is adjusted to pulse grouping described above. The pulse location reduction block 311 performs a reduction procedure on group-by-group basis, where after reduction, every group must have at least one valid position for the initial pulse, otherwise all positions from the group are claimed to be valid.

At this stage, sets of valid pulse positions within groups, the initial pulse position and the gain level are determined. Two remaining pulses are about to be found, each within its group. The contribution of the first pulse is subtracted the same way as described before, and the search is performed through the remaining two groups. A single pulse is found for every of the remaining groups, its contribution is subtracted from target vector, and the group containing the found pulse is removed from search.

Although the present invention has been shown and described with respect to several preferred embodiments thereof, various changes, omissions and additions to the form and detail thereof, may be made therein, without departing from the spirit and scope of the invention.

1. A speech processing system, comprising:
a frame handler unit for dividing the incoming speech signal into frames and subframes of samples;
a short-term analyzer connected to the frame handler unit for calculating short-term characteristics of the frames of the input speech signal;
a short-term redundancy removing unit connected to the short-term analyzer for eliminating short-term characteristics of the frames of the input speech signal and creating noise shaped speech signal;
a long-term analyzer connected to the short-term redundancy removing unit for calculating and predicting long-term characteristics of the noise shaped speech signal;
a long-term redundancy removing unit connected to the long-term analyzer for eliminating long-term characteristics of the noise shaped speech signal or eliminating short-term and long-term characteristics of the frames of the speech input signal, and in such a way creating a target vector; and
an excitation pulse search unit connected to the short-term analyzer and the long-term redundancy removing unit for generating sequences of pulses which are to simulate the target vector, wherein every pulse is of variable position, sign and amplitude.

2. A speech processing system according to claim 1, further comprising a synthesis filter connected to the short-term analyzer and the excitation pulse search unit for generation an impulse response, and the excitation pulse search unit comprising:
a referent vector generator for generating two referent vectors, namely the cross correlation of the target vector and the impulse response and the autocorrelation of the impulse response;
an initial pulse locator connected to the referent vector generator for locating the initial pulse;
an initial pulse quantizer for quantizing the pulses;
a quantization codebook included in the initial pulse quantizer; and
a differential gain level limiter block connected to the initial pulse quantizer for differential coding of the pulse amplitudes by limiting the number of gain values the amplitudes of the pulses in the subframes except for the first subframe can take.

3. A speech processing system according to claim 1, wherein every pulse in a sequence has a gain level that is equal to or smaller that the gain level of the initial pulse.

4. A speech processing system according to claim 1, wherein the short-term analyzer comprises a LPC analyzer.

5. A speech processing system according to claim 1, wherein the long-term analyzer comprises a pitch estimation unit.

6. A speech processing system according to claim 2, wherein the differential gain level limiter block includes a bound adaptive differential coding block for dynamically extending the range of the differential coding.

7. A speech processing system according to claim 2, further comprising a parity selection block connected to the initial pulse quantizer and the referent vector generator for predetermining either all pulses are going to be even or odd.

8. A speech processing system according to claim 7, further comprising a pulse location reduction block connected to the parity selection block for reducing the number of possible pulse positions to be searched.

9. A speech processing system according to claim 8, further comprising a pulse determiner, receiving the referent vector generated by the referent vector generator, the impulse response generated by the synthesis filter, the initial pulse generated by the initial pulse locator, the parity generated by the parity selection block, the pulse gain generated by the differential gain limiter block and the minimized codebook generated by the pulse location reduction block, for generating the optimized pulse sequence.

10. A method of speech processing comprising:
dividing the incoming speech signal into frames and subframes;
calculating short-term characteristics of the frames of the input speech signal;
eliminating short-term characteristics of the frames of the input speech signal and creating noise shaped speech signal;
calculating and predicting long-term characteristics of the noise shaped speech signal;
eliminating long-term characteristics of the noise shaped speech signal or eliminating short-term and long-term characteristics of the frames of the speech input signal, and in such a way creating a target vector; and
generating sequences of pulses of variable position, sign and amplitude which are to simulate the target vector by passing a synthesis filter.

11. A method of speech processing according to claim 10, further comprising
determining for the first subframe the gain level of the pulses, whereby the gain level can take any value from a set of quantized values;
determining the gain level of the pulses for the following subframes, whereby the gain level of the pulses can take only values from a set of several values around the gain level determined for the first subframe.

12. The method of speech processing according to claim 10, wherein every pulse in a sequence has a gain level that is equal to or smaller than the gain level of the initial pulse.

13. The method of speech processing according to claim 11, wherein the set of several values is determined by a range of ±gᵣ around the gain level determined for the first subframe.

14. The method of speech processing according to claim 13 further comprising the step of dynamically extending the range of the differential coding in case of very small or very large gain level values.

15. The method of speech processing according to claim 14, wherein the step of determining the location of the first pulses comprises:
choosing whether pulses are located on even or odd positions only; and
performing the multi-pulse analysis in one pass on even or odd positions only.

16. The method of speech processing according to claim 10, further comprising the step of reducing the number of pulse locations by calculating a referent vector value and abandoning the position if this value is smaller than a determined limit.

17. The method of speech processing according to claim 16, wherein the referent vector value corresponds to the cross correlation of the target vector and the impulse response of the synthesis filter.

18. The method of speech processing according to claim 17, wherein the determined limit is 80% of the quantized gain level.

19. A speech processing system, comprising a short-term analyzer for calculating short-term characteristics of the frames of the input speech signal, wherein the short-term analyzer includes a LPC analyzing unit, comprising:
a LPC calculator receiving the speech samples for calculating LPC coefficients using the Levinson-Durbin algorithm;
a LPC-to-LSP conversion unit connected to the LPC calculator for performing a LPC to LSP transformation; and
a multi-vector quantization unit connected to the LPC-to-LSP conversion unit for quantization of the LSP coefficients either using vector quantization or using combined vector and scalar quantization.

20. The speech processing system according to claim 19, further comprising:
a LSP dequantization unit connected to the multi-vector quantization unit for dequantizing the quantized LSP coefficients.

21. The speech processing system according to claim 20, further comprising:
a LSP-to-LPC conversion unit connected to the LSP dequantization unit for performing a LSP to LPC back-transformation.

22. The speech processing system according to claim 19, further comprising:
a vector codebook included in the multi-vector quantization unit used for quantization.

23. A method of estimating the short-term characteristics of speech frames using a LPC analyzing unit comprising the steps of:
calculating LPC coefficients for the incoming speech samples using a Levinson-Durbin algorithm;
performing a LPC to LSP transformation for the LPC coefficients; and
performing a multi-vector quantization unit for the LSP coefficients either using vector quantization or using combined vector and scalar quantization.

24. The method according to claim 23, further comprising the step of dequantizing the LSP coefficients.

25. The method according to claim 24, further comprising the step of performing a LSP to LPC back-transformation for the LSP coefficients.

26. The method according to claim 25, wherein ten LPC coefficients are created.

27. The method according to claim 23, wherein the number of LPC coefficients is split into variable sized sub-vectors.

28. The method according to claim 27, wherein the variable sized sub-vectors are quantized using vector quantization.

29. The method according to claim 27, wherein the variable sized sub-vectors comprising the most significant coefficients are quantized using scalar quantization, while the other sub-vectors are quantized using vector quantization.

30. The method according to claim 29, wherein vector codebooks 206 are used for quantization.

31. The method according to claim 30, wherein the vector codebooks 206 comprise 128 vector indices per vector.

32. A method for estimating the pitch value for two subframes using normalized autocorrelation function of the speech samples, wherein the search procedure is a hierarchical pitch estimation procedure.

33. The method according to claim 32, comprising the steps of:
calculating the normalized autocorrelation function for every N-th point, whereas smaller values of n are slightly favoured, n indicating possible pitch period values;
receiving a threshold value for the pitch period nₘₐₓ; and
calculation the normalized autocorrelation function in a range around nₘₐₓ to determine precise value of the pitch period.

34. The method according to claim 33, wherein for calculation the normalized autocorrelation function for every N-th point the following formula is used:
$$\begin{matrix}A h ( n ) = \frac{\sum x ( i ) x ( i - n )}{\sum x ( n - i ) x ( n - i )} \\ 18 \leq n \leq 144 , 0 \leq i \leq 2 I - 1 , n = 18 + N \cdot k , k = 0 , 1 , 2 , 3 , … ,\end{matrix}$$
whereas i numbers the samples in two successive subframes each of length I,
and for calculation the normalized autocorrelation function in a range R around nₘₐₓ the following formula is used
$$\begin{matrix}A h ( n ) = \frac{\sum x ( i ) x ( i - n )}{\sum x ( n - i ) x ( n - i )} \\ {n}_{max} - R \leq n \leq {n}_{max} + R , 0 \leq i \leq 2 I - 1 , n \neq 18 + N \cdot k , k = 0 , 1 , 2 , 3 , …\end{matrix}$$

35. The method according to claim 32, comprising the steps of:
dividing the range of possible pitch values in X sub-bands;
calculating the normalized autocorrelation function for every sub-band for every N-th point, without favouring smaller values of n, n indicating possible pitch period values;
determining the threshold value of the pitch period n₁ₘₐₓ, n₂ₘₐₓ, . . . , nₓₘₐₓ, for every sub-band;
comparing the threshold values of the different sub-bands, wherein lower sub-band pitch values are favoured by multiplying the normalized autocorrelation values of higher sub-bands with a factor f smaller than 1;
determining the best of the threshold values of the pitch period n₁ₘₐₓ, n₂ₘₐₓ, . . . , nₓₘₐₓ; and
calculating the normalized autocorrelation function in a range around the best of the threshold values to determine precise value of the pitch period.

36. The method according to claim 35, wherein the factor f is equal to 0.875.

37. The method according to claim 32, wherein the length of the frame is 200 and the length of each subframe I is 50.

38. The method according to claim 32, wherein N is equal to 2.
